(19) United States
(12) Patent Application Publication
(10) Pub. No.: US 2025/0024252 A1
(43) Pub. Date: Jan. 16, 2025

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Yihua MA, Shenzhen (CN); Zhifeng YUAN, Shenzhen (CN); Weimin LI, Shenzhen (CN); Zhigang LI, Shenzhen (CN)

(73) Assignee: ZTE CORPORATION, Shenzhen (CN)

(21) Appl. No.: 18/899,050

(22) Filed: Sep. 27, 2024

Related U.S. Application Data
(63) Continuation of application No. PCT/CN2022/103475, filed on Jul. 1, 2022.

(51) Int. Cl. H04W 12/033; H04W 8/18; H04W 12/043; H04W 12/106; H04W 12/72

(52) U.S. Cl. CPC H04W 12/033; H04W 8/183; H04W 12/043; H04W 12/106; H04W 12/72

(57) ABSTRACT

Method, device and computer program product for wireless communication are provided. A method includes: receiving, by a wireless communication terminal from a wireless communication node, a broadcast signal; and transmitting, by the wireless communication terminal to the wireless communication node, a secure data packet with an encryption based on at least one of: the broadcast signal and/or locally-stored information.

### CROSS-REFERENCE TO RELATED APPLICATION

This application claims the benefit of priority under 35 U.S.C. § 120 as a continuation of International Patent Application No. PCT/CN2022/103475, filed on Jul. 1, 2022, the disclosure of which is incorporated herein by reference in its entirety.

### TECHNICAL FIELD

This document is directed generally to wireless communications, in particular to 5^{th} generation (5G) or 6^{th} generation (6G) wireless communication.

### BACKGROUND

Connectionless transmission is a wireless transmission technology which directly transmits the data packet in the idle or inactive state. It can reduce the transmission overhead of sporadic small packets. However, security mechanisms require to build some security-related contexts before transmission, which limits the practical applications of connectionless transmission.

### SUMMARY

The present disclosure relates to methods, devices, and computer program products for a secure communication.

One aspect of the present disclosure relates to a wireless communication method. In an embodiment, the wireless communication method includes: receiving, by a wireless communication terminal from a wireless communication node, a broadcast signal; and transmitting, by the wireless communication terminal to the wireless communication node, a secure data packet with an encryption based on at least one of: the broadcast signal and/or locally-stored information.

Another aspect of the present disclosure relates to a wireless communication method. In an embodiment, the wireless communication method includes: transmitting, by a wireless communication node to a wireless communication terminal, a broadcast signal; and receiving, by the wireless communication node from the wireless communication terminal, a secure data packet with an encryption based on at least one of: the broadcast signal and/or locally-stored information.

Another aspect of the present disclosure relates to a wireless communication method. In an embodiment, the wireless communication method includes: transmitting, by a core network node to a wireless communication node, information for a decryption of a secure data packet, wherein the secure data packet comprises a ciphertext encrypted based on at least one of: the broadcast signal and/or locally-stored information, and wherein the information comprises at least one of: an encryption key for an encryption of the ciphertext or an integrity protection key for a Message Authentication Code, MAC, of a ciphertext, a Subscription Permanent Identifier, SUPI, a plaintext decrypted from the ciphertext by the wireless communication terminal, or a positive or negative acknowledgement indicating whether the secure data packet is demodulated successfully.

Another aspect of the present disclosure relates to a wireless communication terminal. In an embodiment, the wireless communication terminal includes a communication unit and a processor. The processor is configured to: receive, from a wireless communication node, a broadcast signal; and transmit, to the wireless communication node, a secure data packet with an encryption based on at least one of: the broadcast signal and/or locally-stored information.

Another aspect of the present disclosure relates to a wireless communication node. In an embodiment, the wireless communication node includes a communication unit and a processor. The processor is configured to: transmit, to a wireless communication terminal, a broadcast signal; and receive, from the wireless communication terminal, a secure data packet with an encryption based on at least one of: the broadcast signal and/or locally-stored information.

Another aspect of the present disclosure relates to a core network node. In an embodiment, the wireless communication node includes a communication unit and a processor. The processor is configured to: transmit, to a wireless communication node, information for a decryption of a secure data packet, wherein the secure data packet comprises a ciphertext encrypted based on at least one of: the broadcast signal and/or locally-stored information, and wherein the information comprises at least one of: an encryption key for an encryption of the ciphertext or an integrity protection key for a Message Authentication Code, MAC, of a ciphertext, a Subscription Permanent Identifier, SUPI, a plaintext decrypted from the ciphertext by the wireless communication terminal, or a positive or negative acknowledgement indicating whether the secure data packet is demodulated successfully.

Various embodiments may preferably implement the following features:

Preferably or in some embodiments, the encryption is performed without using context information in earlier transmissions.

Preferably or in some embodiments, the broadcast signal comprises at least one of: a synchronization signal, a resource allocation indication, a paging message, or connectionless security parameters.

Preferably or in some embodiments, the secure data packet comprises at least one of: an identifier of the wireless communication terminal, a ciphertext, a Message Authentication Code, MAC, of the ciphertext, a public key of the wireless communication terminal, a Subscription Concealed Identifier, SUCI, an SUCI-MAC, or a home network, HN, public key indicator.

Preferably or in some embodiments, the identifier of the wireless communication terminal comprises at least one of: a Subscription Permanent Identifier, SUPI, a SUCI, a value of ng-5G-S-TMSI-Part1, a random number, or a value of resumeIdentity.

Preferably or in some embodiments, the secure data packet has an integrity protection based on at least one of: the broadcast signal and/or the locally-stored information.

Preferably or in some embodiments, at least one of an encryption key for an encryption of a ciphertext or an integrity protection key for a MAC of the ciphertext is derived based on a long-term key and connectionless security parameters.

Preferably or in some embodiments, a shared key is generated based on a public key of the wireless communication terminal, a private key of the wireless communication terminal, and an HN public key, and wherein at least one of an encryption key for an encryption of a ciphertext or an integrity protection key for a MAC of the ciphertext is derived based on the shared key.

Preferably or in some embodiments, a ciphertext in the secure data packet is encrypted based on an HN public key.

Preferably or in some embodiments, a pair of public key and private key of the wireless communication terminal are generated for an encryption of a ciphertext.

Preferably or in some embodiments, the wireless communication terminal receives a positive or negative acknowledgement indicating whether the secure data packet is demodulated successfully.

Preferably or in some embodiments, the secure data packet is transmitted via backscattering an excitation signal.

Preferably or in some embodiments, the wireless communication node transmits to a core network node at least one of an identifier of the wireless communication terminal, connectionless security parameters, the secure data packet, a public key of the wireless communication terminal, a Subscription Concealed Identifier, SUCI, or an Subscription Concealed Identifier Message Authentication Code, SUCI-MAC.

Preferably or in some embodiments, the wireless communication node receives from a core network node at least one of: an encryption key for an encryption of a ciphertext, an integrity protection key for an MAC of the ciphertext, a Subscription Permanent Identifier, SUPI, a plaintext decrypted from the ciphertext, or a positive or negative acknowledgement indicating whether the secure data packet is demodulated successfully.

Preferably or in some embodiments, the wireless communication node receives connectionless security parameters from the core network node.

Preferably or in some embodiments, an encryption key received from a core network node is used to decrypt a ciphertext received from the wireless communication terminal.

Preferably or in some embodiments, an integrity protection key received from a core network node is used to generate an MAC for an integration check of a ciphertext received from the wireless communication terminal.

Preferably or in some embodiments, the wireless communication node transmits a positive or negative acknowledgement indicating whether the secure data packet is demodulated successfully to the wireless communication terminal in response to receiving another positive or negative acknowledgement from a core network node, receiving a plaintext of a ciphertext of the secure data packet, or the ciphertext of the secure data packet being demodulated successfully based on an encryption key received from a core network node.

Preferably or in some embodiments, the core network node receives at least one of an identifier of the wireless communication terminal, connectionless security parameters, the secure data packet, a public key of the wireless communication terminal, a Subscription Concealed Identifier, SUCI, or an SUCI-MAC.

Preferably or in some embodiments, the core network node derives at least one of: the encryption key for the encryption of the ciphertext or the integrity protection key for the MAC of the ciphertext according to a long-term key and connectionless security parameters.

Preferably or in some embodiments, the core network node derives a shared key according to a home network, HN, public key, a HN private key, and a public key of the wireless communication terminal, and wherein the shared key is used to derive at least one of the encryption key for the encryption of the ciphertext or the integrity protection key for the MAC of the ciphertext.

Preferably or in some embodiments, the shared key is used to derive keys to check an integrity of a SUCI and to decrypt the SUCI.

Preferably or in some embodiments, the core network node decrypts the ciphertext according to an HN private key.

Preferably or in some embodiments, the locally-stored information comprises at least one of: information stored in universal subscriber identity module, USIM, a transmission session count maintained by both the wireless communication terminal and a core network, or information that the wireless communication terminal is able to obtain in an idle or inactive state.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a diagram of a secure communication according to an embodiment of the present disclosure.

FIG. 2 shows a UE identifier according to an embodiment of the present disclosure.

FIG. 3 shows a diagram of a secure communication according to an embodiment of the present disclosure.

FIG. 4 shows a diagram of a secure communication according to an embodiment of the present disclosure.

FIG. 5 shows a diagram of a secure communication according to an embodiment of the present disclosure.

FIG. 6 shows a diagram of a secure communication according to an embodiment of the present disclosure.

FIG. 7 shows a diagram of a secure communication according to an embodiment of the present disclosure.

FIG. 8 shows a diagram of a secure communication according to an embodiment of the present disclosure.

FIG. 9 shows a schematic diagram of a wireless communication terminal according to an embodiment of the present disclosure.

FIG. 10 shows a schematic diagram of a wireless communication node according to an embodiment of the present disclosure.

### DETAILED DESCRIPTION

The future IoT (Internet of Things) is expected to have massive sporadic short packet transmissions, which requires a lot of access and scheduling resources. In some embodiments, contention-based grant-free technologies may be used to directly transmit short packets without building a connection or a context, which reduces the overhead of scheduling. However, the security requirements limit the efficiency of the connectionless transmission, as the authentication and context information before the transmission are still required. Therefore, in some approaches, security-related context is required to be built before a secure connectionless transmission, which makes the connectionless transmission less efficient. Embodiments of the present invention are provided for a secure connectionless transmission.

### Embodiment 1

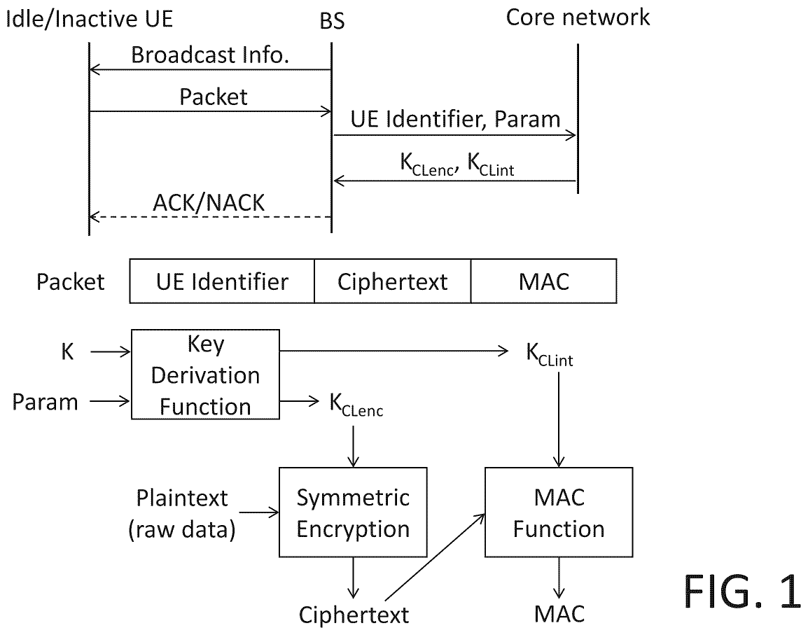

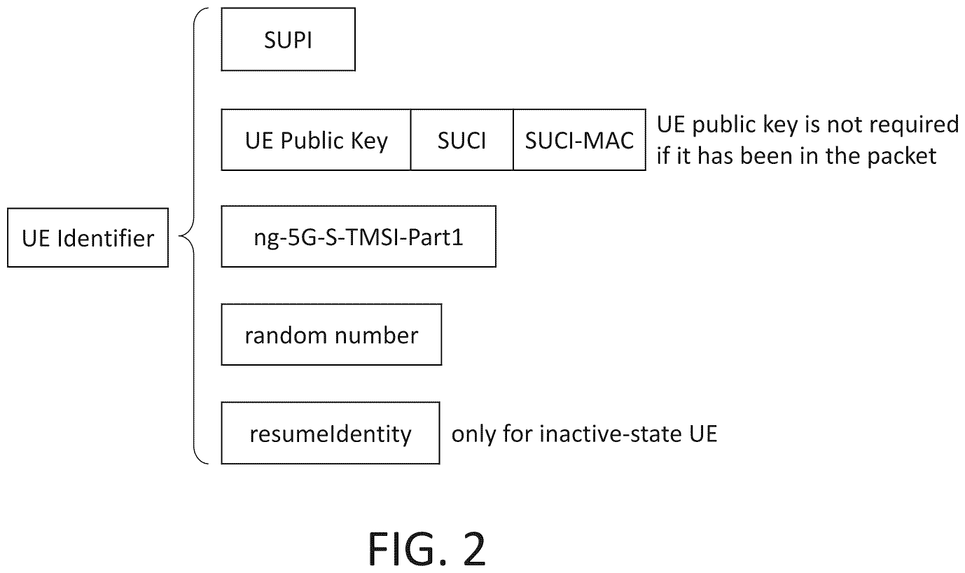

FIG. 1 shows a diagram of a secure communication according to an embodiment of the present disclosure. As illustrated in FIG. 1, the procedure includes the steps below.
1. The BS (base station) transmits broadcast information to an idle or inactive UE. The broadcast information comprises at least one of a synchronization signal, a resource allocation indication, and/or connectionless security parameters. The connectionless security parameters may include a random number acting as the session identifier.
2. The UE uses a long-term key K and the received connectionless security parameters to generate the connectionless encryption key K_{CLenc} and integration protection key K_{CLint}. K_{CLenc} is used to encrypt the plaintext (or raw data bits) into the ciphertext, and K_{CLint} is used to generate a MAC (Message Authentication Code) for integration protection. The UE transmits the packet comprising the UE identifier, the ciphertext and the MAC to the BS. In some embodiments, as illustrated FIG. 2, the UE identifier may include at least one of:
   an SUPI (Subscription Permanent Identifier);
   a combination of a UE public key, an SUCI (Subscription Concealed Identifier), and an SUCI-MAC (Subscription Concealed Identifier Message Authentication Code);
   a value of ng-5G-S-TMSI-Part1;
   a random number; and/or
   a value of resumeIdentity.

In an embodiment, the UE identifier may not include the UE public key if the UE public key is placed in another field of the packet.

In an embodiment, the UE identifier may not include the resume identity when the UE is not in the inactive state.
3. The BS transmits the UE identifier and the connectionless security parameters to the core network.
4. The core network acquires the long-term key K according to the UE identifier (e.g., from a user data management (UDM)), and generates the connectionless encryption key K_{CLenc} and integration protection key K_{CLint} in the same way as the UE generate them. The core network transmits K_{CLenc} and K_{CLint} to the BS.
5. The BS uses K_{CLint} to regenerate a MAC and checks whether the regenerated MAC is the same as the MAC received from the UE. If they are the same, the BS uses K_{CLenc} to decrypt the ciphertext received from the UE to acquire the plaintext. In some embodiments, CRC (cyclic redundancy code) can be used to further check if the plaintext is valid. If the plaintext is successfully decrypted or demodulated, the BS sends an ACK (positive acknowledgement) to the UE. Otherwise, the BS sends an NACK (negative acknowledgement) to the UE. In some embodiments, the operation of sending ACK or NACK may be omitted.

In some embodiments, the UE described above can also be a backscatter node, which backscatters an excitation signal to transmit the packet.

### Embodiment 2

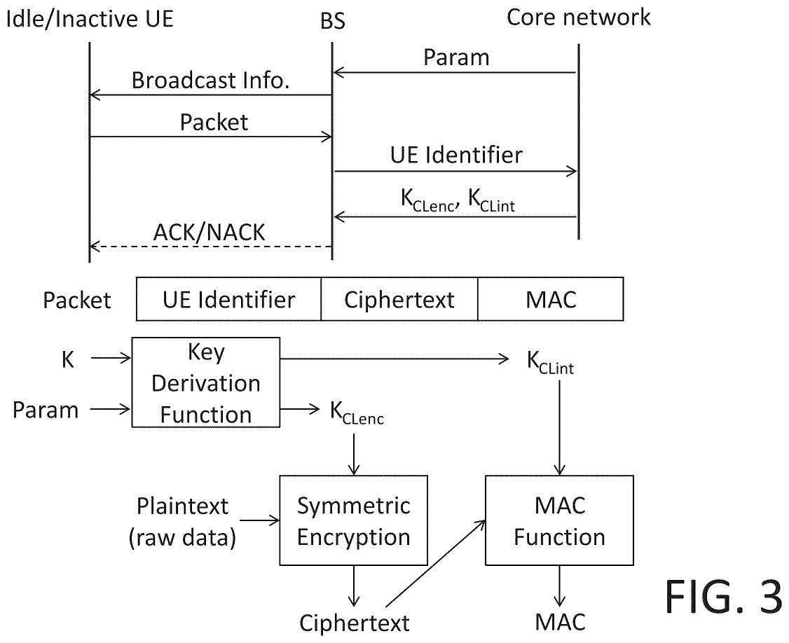

FIG. 3 shows a schematic diagram of another procedure according to an embodiment of the present disclosure. As illustrated in FIG. 3, the procedure includes the steps below.
1. The core network transmits the paging message and connectionless security parameters to the BS. The connectionless security parameters may include a random number acting as the session identifier.
2. The BS transmits broadcast information to an idle or inactive UE. The broadcast information comprises at least one of a synchronization signal, a resource allocation indication, a paging message and/or the connectionless security parameters.
3. The UE uses a long-term key K and the received connectionless security parameters to generate the connectionless encryption key K_{CLenc} and integration protection key K_{CLint}. K_{CLenc} is used to encrypt the plaintext (or raw data bits) into the ciphertext, and K_{CLint} is used to generate a MAC (Message Authentication Code) for integration protection. The UE transmits the packet comprising the UE identifier, the ciphertext and the MAC to the BS. The UE identifier can be ascertained by referring to the embodiment above, and will not be repeated herein.
4. The BS forwards the UE identifier to the core network.
5. The core network acquires the long-term key K according to the UE identifier, and generates the connectionless encryption key K_{CLenc} and integration protection key K_{CLint} in the same way of UE. The core network transmits K_{CLenc} and K_{CLint} to the BS.
6. The BS uses K_{CLint} to regenerate a MAC and checks whether the regenerated MAC is the same as the MAC received from the UE. If they are the same, the BS uses K_{CLenc} to decrypt the ciphertext received from the UE to acquire the plaintext. In some embodiments, CRC (cyclic redundancy code) can be used to further check if the plaintext is valid. If the plaintext is successfully decrypted or demodulated, the BS sends an ACK (positive acknowledgement) to the UE. Otherwise, the BS sends an NACK (negative acknowledgement) to the UE. In some embodiments, the operation of sending ACK or NACK may be omitted.

In some embodiments, the UE described above can also be a backscatter node, which backscatters an excitation signal to transmit the packet.

### Embodiment 3

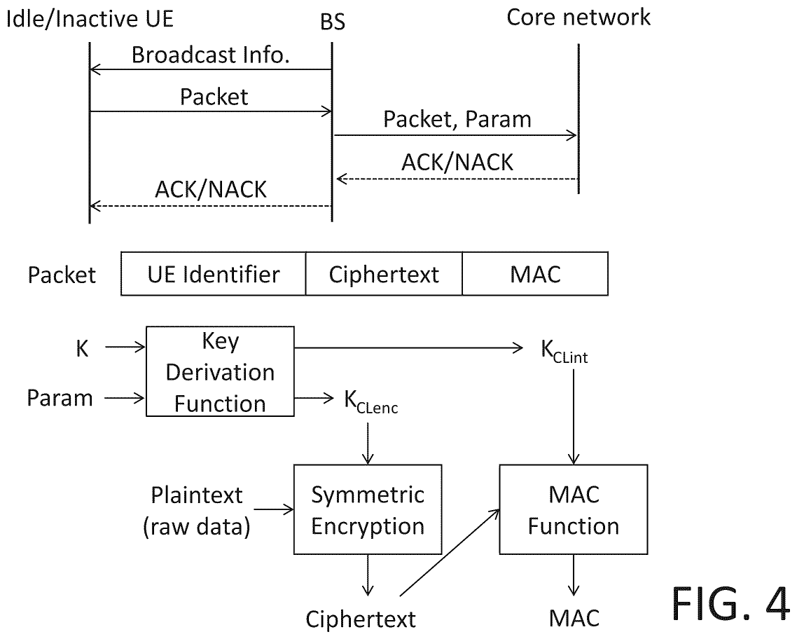

FIG. 4 shows a diagram of a secure communication according to an embodiment of the present disclosure. As illustrated in FIG. 4, the procedure includes the steps below.

Steps 1 to 3 in Embodiment 3 are identical to steps 1 to 3 in Embodiment 1, and will not be repeated herein.
4. The core network acquires the long-term key K according to the UE identifier, and generates the connectionless encryption key K_{CLenc} and integration protection key K_{CLint} in the same way as the UE generate them. The core network uses K_{CLint} to regenerate a MAC and checks whether the regenerated MAC is the same as the MAC received from the UE. If they are the same, the core network uses K_{CLenc} to decrypt the ciphertext received from the UE to acquire the plaintext. In some embodiments, CRC (cyclic redundancy code) can be used to further check if the plaintext is valid. If the plaintext is successfully decrypted or demodulated, the core network sends an ACK to the BS. Otherwise, the core network sends an NACK to the BS. In some embodiments, the operation of sending the ACK or NACK can be omitted.
5. If the core network transmits the ACK to the BS, the BS transmits the ACK to the UE. If the core network transmits the NACK to the BS, the BS transmits the NACK to the UE.

In some embodiments, the UE described above can also be a backscatter node, which backscatters an excitation signal to transmit the packet.

### Embodiment 4

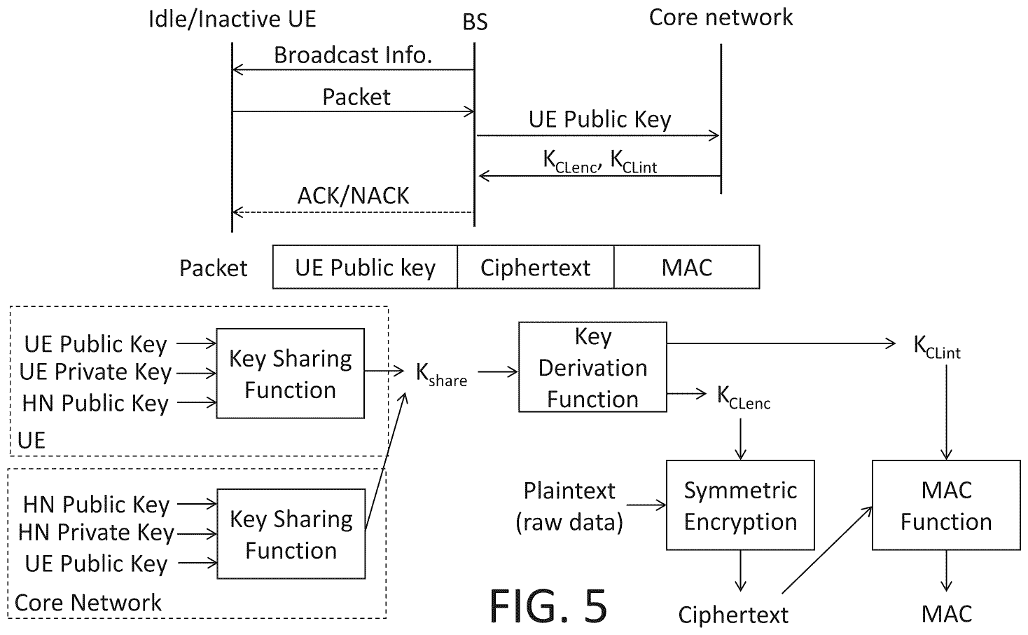

FIG. 5 shows a diagram of a secure communication according to an embodiment of the present disclosure. As illustrated in FIG. 5, the procedure includes the steps below.
1. The BS transmits broadcast information to an idle or inactive UE. The broadcast information comprises at least one of a synchronization signal and/or a resource allocation indication.
2. The UE generates a pair of UE public key and UE private key. The UE uses the UE public key, the UE private key, and the home network (HN) public key to generate a shared key. This shared key is used to derive an encryption key K_{CLenc} and an integrity protection key K_{CLint}. K_{CLenc} is used to encrypt the plaintext (or raw data bits) into the ciphertext, and K_{CLint} is used to generate a MAC (Message Authentication Code) for integration protection. The UE transmits the packet comprising the UE public key, the ciphertext and the MAC to the BS.
3. The BS forwards the UE public key to the core network.
4. The core network uses the home network public key, the home network private key, and the UE public key to generate a shared key. This shared key is used to derive an encryption key K_{CLenc} and an integrity protection key K_{CLint}. The core network transmits K_{CLenc} and K_{CLint} to the BS.
5. The BS uses K_{CLint} to regenerate a MAC and checks whether the regenerated MAC is the same as the MAC received from the UE. If they are the same, the BS uses K_{CLenc} to decrypt the ciphertext received from the UE to acquire the plaintext. In some embodiments, CRC (cyclic redundancy code) can be used to further check if the plaintext is valid. If the plaintext is successfully decrypted or demodulated, the BS sends an ACK (positive acknowledgement) to the UE. Otherwise, the BS sends an NACK (negative acknowledgement) to the UE. In some embodiments, the operation of sending ACK or NACK may be omitted.

In some embodiments, the UE described above can also be a backscatter node, which backscatters an excitation signal to transmit the packet.

### Embodiment 5

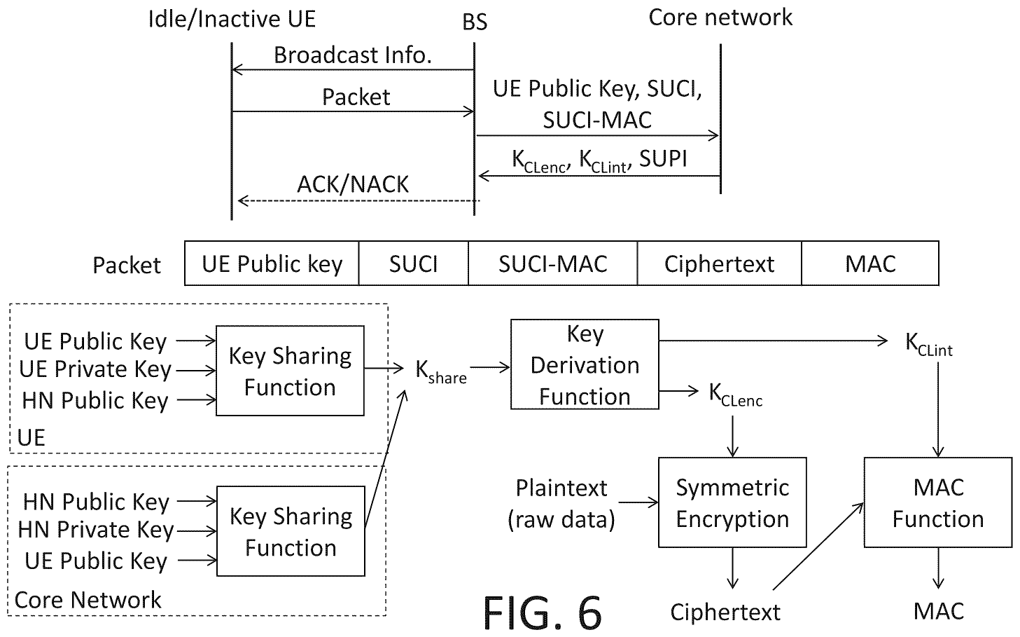

FIG. 6 shows a diagram of a secure communication according to an embodiment of the present disclosure. As illustrated in FIG. 6, the procedure includes the steps below.
1. The BS transmits broadcast information to an idle or inactive UE. The broadcast information comprises at least one of a synchronization signal and/or a resource allocation indication.
2. The UE generates a pair of UE public key and UE private key. The UE uses the UE public key, the UE private key, and the home network public key to generate a shared key. This shared key is used to derive an encryption key K_{CLenc} and an integrity protection key K_{CLint}. K_{CLenc} is used to encrypt the plaintext (or raw data bits) into the ciphertext, and K_{CLint} is used to generate a MAC (Message Authentication Code) for integration protection. The UE transmits the packet comprising the UE public key, the SUCI, the SUCI-MAC, the ciphertext and the MAC to the BS.
3. The BS forwards the UE public key, the SUCI, and the SUCI-MAC to the core network.
4. The core network uses the home network public key, the home network private key, and the UE public key to generate a shared key. This shared key is used to derive keys to check the integrity of the SUCI and decrypt SUCI. This shared key is also used to derive an encryption key K_{CLenc} and an integrity protection key K_{CLint}. The core network transmits K_{CLenc}, K_{CLint} and SUPI to the BS.
5. The BS uses K_{CLint} to regenerate a MAC and checks whether the regenerated MAC is the same as the MAC received from the UE. If they are the same, the BS uses K_{CLenc} to decrypt the ciphertext received from the UE to acquire the plaintext. In some embodiments, CRC (cyclic redundancy code) can be used to further check if the plaintext is valid. If the plaintext is successfully decrypted or demodulated, the BS sends an ACK (positive acknowledgement) to the UE. Otherwise, the BS sends an NACK (negative acknowledgement) to the UE. In some embodiments, the operation of sending ACK or NACK may be omitted.

In some embodiments, the UE described above can also be a backscatter node, which backscatters an excitation signal to transmit the packet.

### Embodiment 6

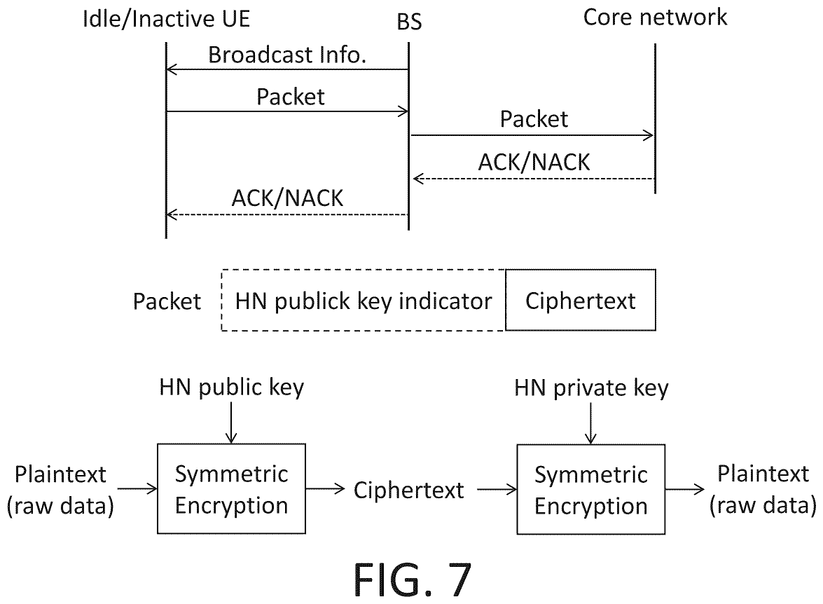

FIG. 7 shows a diagram of a secure communication according to an embodiment of the present disclosure. As illustrated in FIG. 7, the procedure includes the steps below.
1. The BS transmits broadcast information to an idle or inactive UE. The broadcast information comprises at least one of a synchronization signal and/or a resource allocation indication.
2. The UE uses the home network public key to encrypt the plaintext (or raw data bits) into the ciphertext. The UE transmits the packet comprising home network public key indicator and the ciphertext to the BS. In some embodiments, the home network public key indicator is optional.
3. The BS forwards the packet to the core network.
4. The core network uses the home network private key to decrypt the ciphertext to the plaintext. In some embodiments, CRC (cyclic redundancy code) can be used to further check if the plaintext is valid. If the plaintext is successfully decrypted or demodulated, the core network sends an ACK to the BS. Otherwise, the core network sends an NACK to the BS. In some embodiments, the operation of sending the ACK or NACK can be omitted.
5. If the core network transmits the ACK to the BS, the BS transmits the ACK to the UE. If the core network transmits the NACK to the BS, the BS transmits the NACK to the UE.

In some embodiments, the UE described above can also be a backscatter node, which backscatters an excitation signal to transmit the packet.

### Embodiment 7

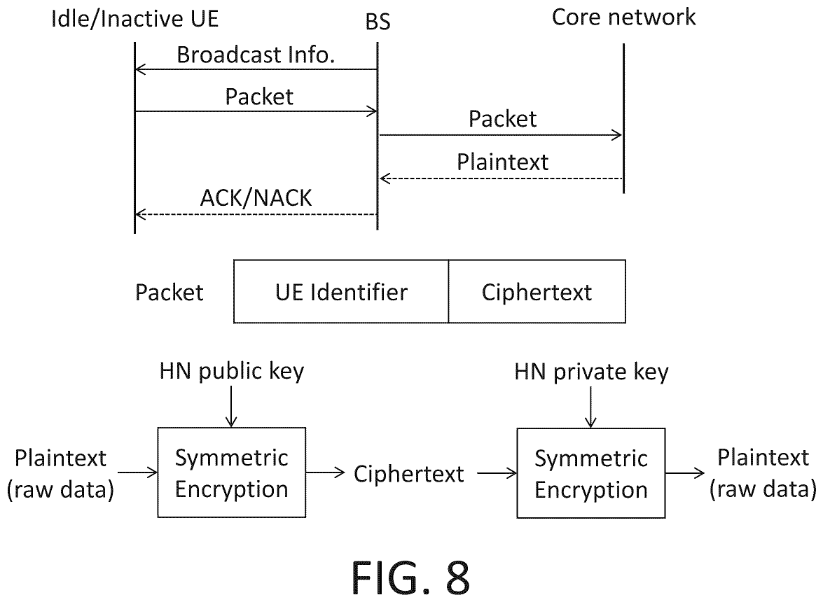

FIG. 8 shows a diagram of a secure communication according to an embodiment of the present disclosure. As illustrated in FIG. 8, the procedure includes the steps below.
1. The BS transmits broadcast information to an idle or inactive UE. The broadcast information comprises at least one of a synchronization signal and/or a resource allocation indication.
2. The UE uses the home network public key to encrypt the plaintext (or raw data bits) into the ciphertext. The UE transmits the packet comprising the UE identifier and ciphertext to the BS. The UE identifier can be ascertained by referring to the embodiment above, and will not be repeated herein.
3. The BS forwards the packet to the core network.
4. The core network uses the home network private key to decrypt the ciphertext to the plaintext. The core network transmits the plaintext to the BS. In some embodiments, the transmission operation can be omitted.
5. In the BS, CRC (cyclic redundancy code) can be used to further check if the plaintext is valid. If the plaintext is successfully decrypted or demodulated, the BS sends an ACK to the UE. Otherwise, the BS sends an NACK to the UE. In some embodiments, the operation of sending the ACK or NACK can be omitted.

In some embodiments, the UE described above can also be a backscatter node, which backscatters an excitation signal to transmit the packet.

According to an embodiment of the present disclosure, a method for wireless communications performed by a user equipment (UE) is provided. The method comprises receiving a broadcast signal comprising at least one of synchronization signal, resource allocation indication, paging message and/or connectionless security parameters from a base station (BS); generating a secure data packet with an encryption without using context information in early transmission or only using the broadcast information; and transmitting the secure data packet to the BS.

According to an embodiment of the present disclosure, the secure data packet comprises information other than UE identifier.

According to an embodiment of the present disclosure, the secure data packet also has integrity protection without using context information in early transmission or only using the broadcast information.

According to an embodiment of the present disclosure, a key derivation procedure is provided, before generating the secure data packet, that derives at least one of an encryption key K_{CLenc} and an integrity protection key K_{CLint} from the long-term key K and the connectionless security parameters.

According to an embodiment of the present disclosure, a key derivation procedure is provided, before generating the secure data packet, that UE uses the UE public key, the UE private key, and the home network public key to generate a shared key, and this shared key is used to derive at least one of an encryption key K_{CLenc} and an integrity protection key K_{CLint}.

According to an embodiment of the present disclosure, the encryption uses home network public key.

According to an embodiment of the present disclosure, the secure transmitting data comprises at least one of a home network public key indicator, the UE public key indicator, and/or a UE identifier. The UE identifier can be an SUPI, an SUCI, ng-5G-S-TMSI-Part1, a random number or resumeIdentity.

According to an embodiment of the present disclosure, the method for wireless communications includes generating UE public key and private key pair before the transmitting data generation.

According to an embodiment of the present disclosure, the method for wireless communications includes monitoring a positive acknowledgement or a negative acknowledgement after transmitting data.

According to an embodiment of the present disclosure, the UE transmits the data packet via backscattering an excitation signal.

According to an embodiment of the present disclosure, a wireless communication method comprises receiving, by a wireless communication terminal (e.g., a UE) from a wireless communication node (e.g., a BS), a broadcast signal; and transmitting, by the wireless communication terminal to the wireless communication node, a secure data packet with an encryption based on at least one of: the broadcast signal and/or the locally-stored information.

In an embodiment, the secure data packet with the encryption can be the packet having the ciphertext described above. In an embodiment, the locally-stored information includes at least one of: information stored in universal subscriber identity module, USIM, a transmission session count maintained by both the wireless communication terminal and a core network, and/or information that the wireless communication terminal is able to obtain in an idle or inactive state. In an embodiment, the locally-stored information may be the long-term key, UE public key, UE private key, or HN public key described above.

In an embodiment, by using the wireless communication method above, the encryption of the secure data packet can be performed without using context information in earlier transmissions.

In an embodiment, the secure data packet may have an integrity protection (e.g., the MAC described above). In an embodiment, the integrity protection is performed also based on at least one of: the broadcast signal and/or the locally-stored information.

In an embodiment, by using the wireless communication method above, the integrity protection of the secure data packet can be performed without using context information in earlier transmissions.

According to an embodiment of the present disclosure, a wireless communication method comprises transmitting, by a wireless communication node to a wireless communication terminal, a broadcast signal; and receiving, by the wireless communication node from the wireless communication terminal, a secure data packet with an encryption based on at least one of: the broadcast signal and/or locally-stored information.

Details in this regard can be ascertained by referring to the embodiments above.

According to an embodiment of the present disclosure, a wireless communication method comprises transmitting, by a core network node to a wireless communication node, information for a decryption of a secure data packet, wherein the secure data packet comprises a ciphertext encrypted based on at least one of: the broadcast signal and/or locally-stored information, and wherein the information comprises at least one of: an encryption key for an encryption of the ciphertext or an integrity protection key for a Message Authentication Code, MAC, of a ciphertext, a Subscription Permanent Identifier, SUPI, a plaintext decrypted from the ciphertext by the wireless communication terminal, or a positive or negative acknowledgement indicating whether the secure data packet is demodulated successfully.

In an embodiment, the core network node receives at least one of an identifier of the wireless communication terminal, connectionless security parameters, the secure data packet, a public key of the wireless communication terminal, a Subscription Concealed Identifier, SUCI, or an SUCI-MAC (i.e., an MAC of the SUCI).

Details in this regard can be ascertained by referring to the embodiments above.

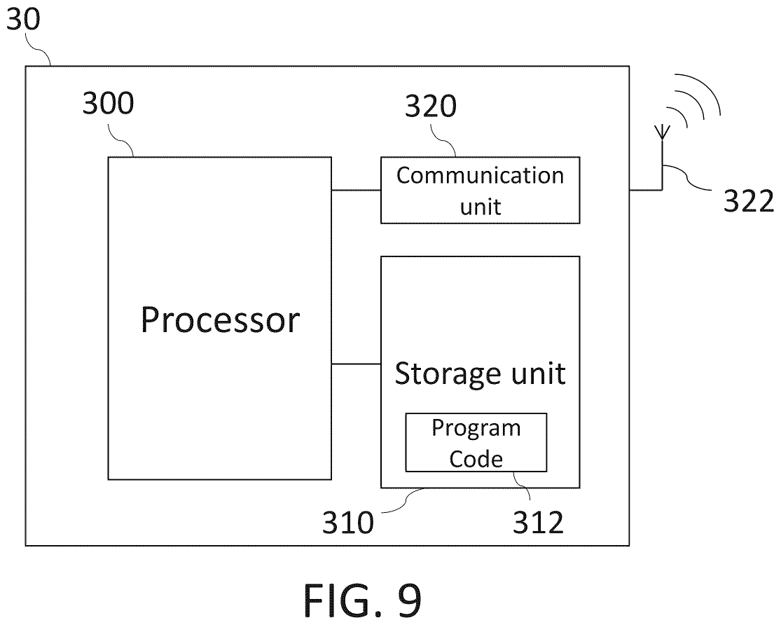

FIG. 9 relates to a schematic diagram of a wireless communication terminal 30 (e.g., a terminal node or a terminal device) according to an embodiment of the present disclosure. The wireless communication terminal 30 may be a user equipment (UE), a remote UE, a relay UE, a mobile phone, a laptop, a tablet computer, an electronic book, or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the UE described above. In some embodiments, the processor 300 and the communication unit 320 collaboratively perform the operations described above. For example, the processor 300 performs operations and transmit or receive signals, message, and/or information through the communication unit 320.

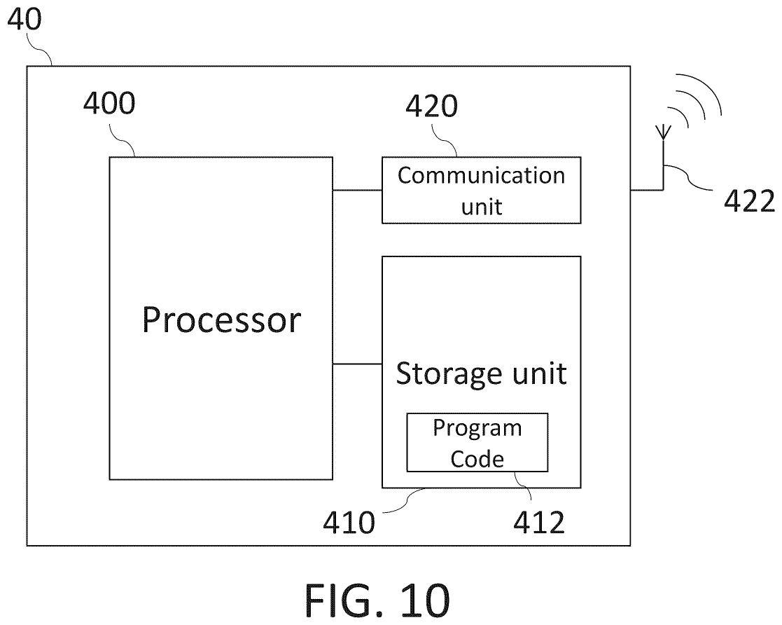

FIG. 10 relates to a schematic diagram of a wireless communication node 40 (e.g., a network device) according to an embodiment of the present disclosure. The wireless communication node 40 may be a satellite, a base station (BS), a gNB, a gNB-DU, a gNB-CU, a network entity, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the BS or the core network (e.g., a core network node) described above. In some embodiments, the processor 400 and the communication unit 420 collaboratively perform the operations described above. For example, the processor 400 performs operations and transmit or receive signals through the communication unit 420.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
receiving, by a wireless communication terminal from a wireless communication node, a broadcast signal; and
transmitting, by the wireless communication terminal to the wireless communication node, a secure data packet with an encryption based on at least one of: the broadcast signal and locally-stored information.

2. The wireless communication method of claim 1, wherein the locally-stored information comprises at least one of: information stored in universal subscriber identity module (USIM), a transmission session count maintained by both the wireless communication terminal and a core network, or information that the wireless communication terminal is able to obtain in an idle or inactive state.

3. The wireless communication method of claim 1, wherein the broadcast signal comprises at least one of: a synchronization signal, a resource allocation indication, a paging message, or connectionless security parameters.

4. The wireless communication method of claim 1, wherein the secure data packet comprises at least one of: an identifier of the wireless communication terminal, a ciphertext, a Message Authentication Code (MAC) of the ciphertext, a public key of the wireless communication terminal, a Subscription Concealed Identifier (SUCI), an SUCI-MAC, or a home network (HN) public key indicator;
wherein the identifier of the wireless communication terminal comprises at least one of: a Subscription Permanent Identifier (SUPI), a SUCI, a value of ng-5G-S-TMSI-Part1, a random number, or a value of resumeIdentity.

5. The wireless communication method of claim 1, wherein the secure data packet has an integrity protection based on at least one of: the broadcast signal and the locally-stored information;
wherein at least one of an encryption key for an encryption of a ciphertext or an integrity protection key for a MAC of the ciphertext is derived based on a long-term key and connectionless security parameters.

6. The wireless communication method of claim 1, wherein a shared key is generated based on a public key of the wireless communication terminal, a private key of the wireless communication terminal, and an HN public key, and wherein at least one of an encryption key for an encryption of a ciphertext or an integrity protection key for a MAC of the ciphertext is derived based on the shared key.

7. The wireless communication method of claim 1, wherein a ciphertext in the secure data packet is encrypted based on an HN public key;
wherein a pair of public key and private key of the wireless communication terminal are generated for an encryption of a ciphertext;
wherein the wireless communication terminal receives a positive or negative acknowledgement indicating whether the secure data packet is demodulated successfully;
wherein the secure data packet is transmitted via backscattering an excitation signal.

8. A wireless communication method comprising:
transmitting, by a wireless communication node to a wireless communication terminal, a broadcast signal; and
receiving, by the wireless communication node from the wireless communication terminal, a secure data packet with an encryption based on at least one of: the broadcast signal and locally-stored information.

9. The wireless communication method of claim 8, wherein the wireless communication node transmits to a core network node at least one of an identifier of the wireless communication terminal, connectionless security parameters, the secure data packet, a public key of the wireless communication terminal, a Subscription Concealed Identifier (SUCI), or an Subscription Concealed Identifier Message Authentication Code (SUCI-MAC).

10. The wireless communication method of claim 8, wherein the wireless communication node receives from a core network node at least one of: an encryption key for an encryption of a ciphertext, an integrity protection key for an MAC of the ciphertext, a Subscription Permanent Identifier (SUPI), a plaintext decrypted from the ciphertext, or a positive or negative acknowledgement indicating whether the secure data packet is demodulated successfully.

11. The wireless communication method of claim 8, wherein the wireless communication node receives connectionless security parameters from the core network node;
wherein an encryption key received from a core network node is used to decrypt a ciphertext received from the wireless communication terminal;
wherein an integrity protection key received from a core network node is used to generate an MAC for an integration check of a ciphertext received from the wireless communication terminal.

12. The wireless communication method of claim 8, wherein the wireless communication node transmits a positive or negative acknowledgement indicating whether the secure data packet is demodulated successfully to the wireless communication terminal in response to receiving another positive or negative acknowledgement from a core network node, receiving a plaintext of a ciphertext of the secure data packet, or the ciphertext of the secure data packet being demodulated successfully based on an encryption key received from a core network node.

13. The wireless communication method of claim 8, wherein the broadcast signal comprises at least one of: a synchronization signal, a resource allocation indication, a paging message, or connectionless security parameters.

14. The wireless communication method of claim 8, wherein the secure data packet comprises at least one of: an identifier of the wireless communication terminal, a ciphertext, a Message Authentication Code (MAC) of the ciphertext, a public key of the wireless communication terminal, a Subscription Concealed Identifier (SUCI), an SUCI-MAC, or a home network (HN) public key indicator;
wherein the identifier of the wireless communication terminal comprises at least one of: a Subscription Permanent Identifier (SUPI), a SUCI, a value of ng-5G-S-IMSI-Part1, a random number, or a value of resumeIdentity.

15. The wireless communication method of claim 8, wherein the secure data packet has an integrity protection based on at least one of: the broadcast signal and the locally-stored information.

16. A wireless communication method comprising:
transmitting, by a core network node to a wireless communication node, information for a decryption of a secure data packet, wherein the secure data packet comprises a ciphertext encrypted based on at least one of: the broadcast signal and locally-stored information, and wherein
the information comprises at least one of: an encryption key for an encryption of the ciphertext or an integrity protection key for a Message Authentication Code (MAC) of a ciphertext, a Subscription Permanent Identifier (SUPI), a plaintext decrypted from the ciphertext by the wireless communication terminal, or a positive or negative acknowledgement indicating whether the secure data packet is demodulated successfully.

17. The wireless communication method of claim 16, wherein the core network node receives at least one of an identifier of the wireless communication terminal, connectionless security parameters, the secure data packet, a public key of the wireless communication terminal, a Subscription Concealed Identifier (SUCI), or an SUCI-MAC.

18. The wireless communication method of claim 16, wherein the core network node derives at least one of: the encryption key for the encryption of the ciphertext or the integrity protection key for the MAC of the ciphertext according to a long-term key and connectionless security parameters.

19. The wireless communication method of claim 16, wherein the core network node derives a shared key according to a home network (HN) public key, a HN private key, and a public key of the wireless communication terminal, and wherein the shared key is used to derive at least one of the encryption key for the encryption of the ciphertext or the integrity protection key for the MAC of the ciphertext;
wherein the shared key is used to derive keys to check an integrity of a SUCI and to decrypt the SUCI.

20. The wireless communication method of claim 16, wherein the core network node decrypts the ciphertext according to an HN private key.
